(19) United States
(12) Patent Application Publication
(10) Pub. No.: US 2005/0076533 A1
(43) Pub. Date: Apr. 14, 2005

(54) Fabric article treating device and system with suggestive scent

(76) Inventors: Eric Joseph Huston, Cincinnati, OH (US); Dean Larry DuVal, Lebanon, OH (US); Laura Lynn Heilman, Cincinnati, OH (US)

Correspondence Address: The Procter & Gamble Company;IP Division Central Docketing, WHBC - FC Box 161, 6110 Center Hill Avenue, Cincinnati, OH, 45224, US

(21) Appl. No.: 10/927,211

(22) Filed: Aug. 26, 2004

Related U.S. Application Data
(63) Continuation-in-part of application No. 10/842,926, filed on May 11, 2004.
Application No. 10/842,926 is a continuation-in-part of application No. 10/839,549, filed on May 5, 2004.
Application No. 10/839,549 is a continuation-in-part of application No. 10/762,152, filed on Jan. 21, 2004.
Application No. 10/762,152 is a continuation-in-part of application No. 10/697,736, filed on Oct. 29, 2003.
Application No. 10/762,152 is a continuation-in-part of application No. 10/697,734, filed on Oct. 29, 2003.
Application No. 10/762,152 is a continuation-in-part of application No. 10/697,685, filed on Oct. 29, 2003.
Application No. 10/762,152 is a continuation-in-part of application No. 10/697,735, filed on Oct. 29, 2003.
Application No. 10/697,735 is a continuation-in-part of application No. 10/418,595, filed on Apr. 17, 2003.
(60) Provisional application No. 60/568,771, filed on May 6, 2004.
(60) Provisional application No. 60/374,601, filed on Apr. 22, 2002.
(60) Provisional application No. 60/426,438, filed on Nov. 14, 2002.

(51) Int. Cl. F26B 11/02

(52) U.S. Cl. 34/597

(57) ABSTRACT

A fabric article treating device includes a dispenser adapted for location inside of a fabric article drying appliance and a reservoir adapted to contain a benefit composition. The dispenser and the reservoir are adapted for fluid communication with one another. At least an exterior portion of the reservoir provides a scent suggestive of a scent provided by the benefit composition.

### CROSS REFERENCE TO RELATED APPLICATIONS

This application claims the benefit of U. S. Provisional Application Serial No. 60/568,771 entitled “Uniform Delivery of Compositions”, filed on May 6, 2004 and is a continuation-in-part of U.S. Ser. No. 10/842,926 entitled “Fabric Article Treating System and Method”, filed on May 11, 2004; which is a continuation-in-part of U.S. Ser. No. 10/839,549 entitled “Processes and Apparatuses for Applying a Benefit Composition to One or More Fabric Articles During a Fabric Enhancement Operation”, filed on May 5, 2004; which is a continuation-in-part of U.S. Ser. No. 10/762,152, entitled “Volatile Material Delivery Method”, filed on Jan. 21, 2004; which is a continuation-in-part of U.S. Ser. No. 10/697,736, entitled “Fabric Article Treating Method and Device Comprising a Heating Means”, filed on Oct. 29, 2003; U.S. Ser. No. 10/697,734, entitled “Thermal Protection of Fabric Article Treating Device”, filed on Oct. 29, 2003; U.S. Ser. No. 10/697,685, entitled “Fabric Article Treating Device Comprising More Than One Housing”, filed on Oct. 29, 2003; and U.S. Ser. No. 10/697,735, entitled “Fabric Article Treating Apparatus with Safety Device and Controller”, filed Oct. 29, 2003; each of which is a continuation-in-part of U.S. Ser. No. 10/418,595, entitled “Fabric Article Treating Method and Apparatus”, filed on Apr. 17, 2003, which claims the benefit of U. S. Provisional Application Ser. No. 60/374,601, filed Apr. 22, 2002 and U. S. Provisional Application Ser. No. 60/426,438, filed Nov. 14, 2002.

### FIELD OF THE INVENTION

The present invention relates to a fabric article treating device for use with a fabric article drying appliance, and more specifically to a unique fabric article treating device and system for dispensing a benefit composition, employing a reservoir with a suggestive scent.

### BACKGROUND OF THE INVENTION

Fabric article treating methods and/or apparatuses have been evolving over the past twenty years. For example, U.S. Pat. No. 4,207,683 describes a conventional automatic clothes dryer that incorporates a spray dispenser capable of dispensing liquids into the drum of the dryer. U.S. Pat. Nos. 4,642,908, 5,771,604 and 6,067,723 describe other variations of conventional clothes drying appliances.

There exists an ongoing need to develop a fabric article treating method and/or apparatus, especially an in-home fabric article treating method and/or apparatus, that improves/enhances the deposition of fabric article actives or benefit agents on the fabric articles being treated as compared to the currently existing deposition methods and/or apparatuses.

One particular challenge presented in the delivery of fabric article actives in the fabric article drying environment is the effect of moisture and heat, both during handling of a product in the chain of commerce and as generated during the drying of the fabric articles. Particularly, storage containers or reservoirs are sealed to minimize effects of such conditions, thereby minimizing bacterial and fungal growth especially on headspace surfaces such as lids or caps, subject to repeated condensation and perspiration, and to avoid product loss or contamination.

Typically, before purchasing a product which may impart a scent to a fabric article, a consumer desires to smell the scent of the product to determine if the scent is pleasing and/or acceptable. However, if the product, such as a fabric article treating composition, has one or more sealed reservoirs configured to maintain a sealed environment within the reservoir prior to use, the consumer is typically unable to smell the scent of the product until the time of use without damaging the package or the sealed environment. This inability to smell deprives the consumer of the first moment of truth impression of the product before purchase of the product. Current alternatives, such as scratch-and-sniff stickers are typically expensive alternatives requiring additional consumer interactions and steps in order to determine if the perfume character of the product is to their liking. As such, it would be advantageous to provide a fabric article treating device comprising a reservoir which maintains a sealed environment while providing to a consumer a first moment of truth scent impression, without requiring additional consumer interactions with the package.

### SUMMARY OF THE INVENTION

The present invention is directed to fabric article treating devices and fabric article treating systems. More particularly, the invention is directed to fabric article treating devices in which an exterior portion of a reservoir included therein provides a scent suggestive of a scent provided by the benefit composition.

One embodiment of the present invention is a fabric article treating device. The fabric article treating device comprises a dispenser adapted for location inside of a fabric article drying appliance, and a reservoir. The dispenser and the reservoir are adapted for fluid communication with one another. The reservoir contains a benefit composition, and an exterior portion of the reservoir provides a scent suggestive of a scent provided by the benefit composition.

Another embodiment of the present invention is a fabric article treating device. The fabric article treating device comprises a reservoir adapted for containing a benefit composition and a fitment configured to preserve the anaerobic environment within the reservoir during storage of the benefit composition in the reservoir and dispensing of the benefit composition from the reservoir. An exterior portion of the reservoir provides a scent suggestive of a scent provided by the benefit composition.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a schematic illustration of an exemplary fabric article treating device according to a first embodiment of the present invention;

FIG. 2 is a schematic illustration of an exemplary fabric article treating device according to a second embodiment of the present invention;

FIG. 3 is a schematic illustration of an exemplary fabric article treating device according to a third embodiment of the present invention;

FIG. 4 is a schematic illustration of an exemplary reservoir according to a fourth embodiment of the present invention;

FIG. 5 is a schematic illustration of an exemplary fabric article treating device according to a fifth embodiment of the present invention;

FIG. 6 is a schematic illustration of an exemplary fabric article treating device according to a sixth embodiment of the present invention;

FIG. 7 is a schematic illustration of an exemplary fabric article treating device according to a seventh embodiment of the present invention;

FIG. 8 is a schematic illustration of an exemplary fabric article treating device according to a eighth embodiment of the present invention;

FIG. 9 is a schematic illustration of an exemplary fabric article treating system according to a ninth embodiment of the present invention; and

FIG. 10 is a schematic illustration of an exemplary fabric article treating system according to a tenth embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments of the invention, examples of which are illustrated in the accompanying drawings, wherein like numerals indicate similar elements throughout the views.

### DEFINITIONS

The phrase “fabric article treating system” as used herein means a fabric article drying appliance, a non-limiting example of which includes a conventional clothes dryer and/or modifications thereof. The fabric article treating system also includes a fabric article treating apparatus which may be discreet in relation to the fabric article drying appliance and/or it may be integrated into the fabric article drying appliance. Furthermore, the fabric article treating apparatus may be integrated into a readily replaceable portion of the fabric article drying appliance, a non-limiting example of which includes a closure structure of the drying appliance.

“Fabric article” or “fabric” as used herein means any article that is customarily cleaned in a conventional laundry process or in a dry cleaning process. The term encompasses articles of fabric including, but not limited to, clothing, linen, drapery, clothing accessories, leather, floor coverings, sheets, towels, rags, canvas, polymer structures, and the like. The term also encompasses other items made in whole or in part of fabric material, such as tote bags, furniture covers, tarpons, shoes, and the like.

As used herein, the term “benefit composition” refers to a composition used to deliver a benefit to a fabric article. Non-limiting examples of materials and mixtures thereof which can comprise the benefit composition include: water, softening agents, crispening agents, perfume, water/stain repellants, refreshing agents, antistatic agents, antimicrobial agents, durable press agents, wrinkle resistant agents, odor resistance agents, abrasion resistance agents, solvents, and combinations thereof. The benefit composition may comprise a liquid, a powder, a suspension, or gaseous product, and/or a combination of such. In one embodiment, the benefit composition includes a preservative. Various preservatives which help maintain one or more properties of the benefit composition are generally known in the art and are suitable for use herein. Exemplary preservatives include Dantoguard Plus™ (Dimethylol-5,5-Dimethylhydantoin) commercially available from Lonza; Kathon™ (isothiazolinones) commercially available from Rohm & Haas; and Integra 44™ (Sodium hydroxymethylglycinate) commercially available from International Specialty Products (ISP).

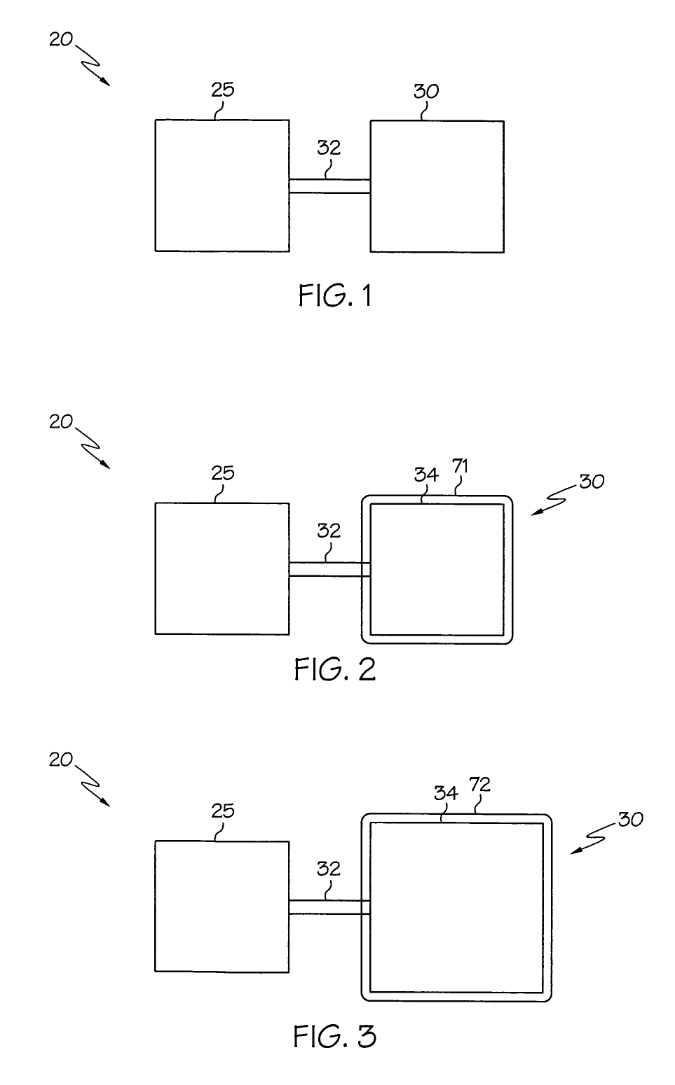

FIG. 1 illustrates an exemplary fabric article treating device 20 according to one embodiment of the present invention. The fabric article treating device 20 comprises a dispenser 25 adapted for location inside of a fabric article drying appliance and a reservoir 30. The dispenser 25 and the reservoir 30 are adapted for fluid communication with one another, for example via fluid line 32. The reservoir 30 contains a benefit composition and an exterior portion of the reservoir provides a scent suggestive of a scent provided by the benefit composition. In one embodiment, the fluid connection between the dispenser 25 and the reservoir 30 comprises tubing configured to allow the benefit composition to be transported from the reservoir 30 to the dispenser 25. One exemplary tubing comprises a polymeric tubing with one or more channels or conduits. In one embodiment, the tubing is configured to allow the closure structure on the fabric article drying appliance to maintain a closed position while still permitting dispensing of the benefit composition. An exterior portion of the reservoir 30 provides a scent suggestive of a scent provided by the benefit composition. In one exemplary embodiment, the reservoir 30 is removable. In another exemplary embodiment, the reservoir 30 comprises a sealed pouch.

The reservoir 30 may be constructed of any material known in the art. Non-limiting examples of such materials include polymeric materials including but not limited to polypropylene, polyethylene, styrenics, polyesters, polyethylene terephthalate (PET), polycarbonates, PMMA, polyvinyls, polyurethane, acrylic, epoxies, acetates, acrylonitrile-butadiene-styrene, fluoropolymers, latex, nitrile copolymers, nylons, polychloroprene, polyvinylchloride, Rayon, rubbers (natural and synthetic), silicone, and combinations thereof. Other exemplary materials of construction include metals, for example aluminum foil. In one embodiment, the reservoir 30 comprises multiple layers of one or more materials. In another embodiment, the reservoir 30 comprises a single or multiple layer barrier film. In one embodiment, the reservoir comprises a multi-layer barrier film having an outer layer and at least one inner layer, and wherein the outer layer provides a scent suggestive of a scent provided by the benefit composition. In an alternative embodiment, at least one layer of the multi-layer barrier film provides a scent suggestive of a scent provided by the benefit composition.

In one exemplary embodiment, the scent of the exterior portion comprises one or more fragrances. The fragrances employed in the present invention are not critical, so long at they are compatible with the material, such as a polymer, that is employed in the exterior of the reservoir. As is appreciated in the art, some polymers and fragrances are not compatible with each other. The fragrances of the present invention in one embodiment can be continually delivered over an extended period of time. Technologies that control the release of fragrances are well known in the art and include encapsulation and the use of emulsions and surfactants. One aspect of Applicants' invention is a perfume, that comprises at least about 30 wt. %, alternatively from about 35 wt % to about 100 wt. %, alternatively from about 40 wt % to about 100 wt. % or altematively from about 40 wt % to about 70 wt. % of a perfume material having a boiling point of less than or equal to about 250° C. at about 1 atmosphere; a fabric treatment material; an optional carrier and the balance one or more adjunct ingredients.

Examples of suitable perfume materials that have a boiling point of less than or equal to 250° C. at 1 atmosphere, include but are not limited, to: Allyl cyclohexanepropionate, Allyl heptanoate, Allyl caproate, Allo-ocimene, Amyl acetate (n-pentyl acetate), Amyl propionate, Acetanisole, p-Anisaldehyde, Anisole, trans-Anethole, Benzaldehyde (Benezenecarboxaldehyde), Benzylacetate, Benzyl butyrate, Benzyl acetone, Benzyl alcohol, Benzyl formate, Benzyl propionate, Beta-gamma-hexanol (2-hexen-1-ol), (+)-Camphor, Cadinene, Camphene, Carvacrol, Cis-3-hexenyl tiglate, (+)-Carvone, Citronellol, Citronellyl acetate, Citronellyl nitrile, Citronellyl propionate, Cyclohexylethyl acetate, L-Carvone, Cinnamic alcohol, Cinnamyl formate, cis-Jasmone, Cis-3-hexenyl acetate, Citral (Neral), Cumic alcohol, Cuminaldehyde, 2,4-dimethyl-3-cyclohexene-1-carboxaldehyde, Dimethyl benzyl carbinol, Dimethyl benzyl carbinyl acetate, Decyl Aldehyde (Capraldehyde), Dihydromyrcenol, Dihydromyrcenyl acetate, 3,7-Dimethyl-1-octanol, Diphenyloxide, Ethyl acetate, Ethyl acetoacetate, Ethyl amyl ketone, Ethyl benzoate, Ethyl butanoate, 3-Nonanone (ethyl hexyl ketone), Ethyl phenylacetate, Eucalyptol, Eugenol, Fenchyl alcohol, Fenchyl Acetate (1,3,3-trimethyl-2-norbornanyl acetate), tricyclodecenyl acetate, tricyclodecenyl propionate, Gamma-nonalactone, Geranyl acetate, Geranyl formate, Geranyl nitrile, Trans-Geraniol, cis-3-Hexenyl isobutyrate, Hexyl neopentanoate, Hexyl tiglate, Cis-3-Hexen-1-ol/Leaf alcohol, Hexyl acetate, Hexyl formate, Hydratopic alcohol, Hydroxycitronellal, Alpha-Ionone, Isobornyl acetate, Isobutyl benzoate, Isononyl acetate, Isononyl alcohol (3,5,5-trimethyl-1-hexanol), Isopulegyl acetate, Indole (2,3-benzopyrrole), Isoamyl alcohol, Isopropyl phenylacetate, Isopulegol, Isoquinoline (Benzopyridine), Lauraldehyde, d-Limonene, Linalyl acetate, 2,3-dimethyl-3-cyclohexene-1-carboxaldehyde, Linalool, Linalool oxide, Linalyl formate, Menthone, (−)-L-Menthyl acetate, Methyl Chavicol (Estragole), Methyl n-nonyl acetaldehyde, Methyl octyl acetaldehyde, Beta-Myrcene, 4-Methylacetophenone, Methyl pentyl ketone, Methyl anthranilate, Methyl benzoate, Methyl Phenyl Carbinyl Acetate (alpha-methylbenzyl acetate), Methyl eugenol (eugenol methyl ether), Methyl Heptenone (6-Methyl-5-hepten-2-one), Methyl Heptine Carbonate (methyl 2-octynoate), Methyl heptyl ketone, Methyl hexyl ketone, Methyl salicylate, Dimethyl anthranilate, Neryl acetate, Nonyl acetate, Nonaldehyde, Nerol, Delta-Nonalactone, Gamma-Octalactone, 2-octanol, Octyl aldehyde (caprylic aldehyde), p-Cresol, p-Cymene, Alpha-Pinene, Beta-Pinene, p-Cresyl methyl ether, 2-phenoxyethanol, Phenylacetaldehyde, 2-Phenylethyl acetate, Phenylethyl alcohol, Phenyl ethyl dimethyl carbinol (benzyl-tert-butanol), Prenyl acetate, Propyl butanoate, (+)-Pulegone, methyl iso butenyl tetrahydro pyran, Safrole, 4-terpinenol, Alpha-Terpinene, Gamma-Terpinene, Alpha-Terpinyl acetate, Tetrahydrolinalool, Tetrahydromyrcenol, Terpinolene (alpha-Terpineol), 2-Undecenal, 1,2-dimethoxybenzene, phenylacetaldehyde dimethyl acetal, o-t-butylcyclohexyl acetate, 4-tert-butylcyclohexyl acetate.

In another aspect of Applicants' invention examples of suitable perfume materials that have a boiling point of less than or equal to 250° C. at 1 atmosphere, include but are not limited, to: Allyl caproate, Amyl acetate (n-pentyl acetate), Amyl propionate, p-Anisaldehyde, Anisole, Benzaldehyde (Benezenecarboxaldehyde), Benzylacetate, Benzyl acetone, Benzyl alcohol, Benzyl formate, (+)-Camphor, (+)-Carvone, L-Carvone, Cinnamic alcohol, Cis-3-hexenyl acetate, Citral (Neral), 2,4-dimethyl-3-cyclohexene-1-carboxaldehyde, Dimethyl benzyl carbinol, Dimethyl benzyl carbinyl acetate, Ethyl acetate, Ethyl acetoacetate, Ethyl amyl ketone, Ethyl benzoate, Eucalyptol, Eugenol, Fenchyl alcohol, tricyclodecenyl acetate, tricyclodecenyl propionate, Gamma-nonalactone, Trans-Geraniol, Cis-3-Hexen-1-ol/Leaf alcohol, Hexyl acetate, Hydroxycitronellal, Ligustral (2,3-dimethyl-3-cyclohexene-1-carboxaldehyde), Linalool, Linalool oxide, Linalyl formate, Menthone, 4-Methylacetophenone, Methyl anthranilate, Methyl benzoate, Methyl Phenyl Carbinyl Acetate (alpha-methylbenzyl acetate), Methyl eugenol (eugenol methyl ether), Methyl Heptine Carbonate (methyl 2-octynoate), Methyl heptyl ketone, Methyl hexyl ketone, Methyl salicylate, Dimethyl anthranilate, Nerol, Delta-Nonalactone, Gamma-Octalactone, Octyl aldehyde (caprylic aldehyde), p-Cresyl methyl ether, Phenylacetaldehyde, Phenylethyl alcohol, Phenyl ethyl dimethyl carbinol (benzyl-tert-butanol), Prenyl acetate, methyl iso butenyl tetrahydro pyran, Terpinolene (alpha-Terpineol), Allo-ocimene, Allyl cyclohexanepropionate, Allyl heptanoate, trans-Anethole, Benzyl butyrate, Camphene, Citronellol, Citronellyl acetate, Citronellyl nitrile, Decyl Aldehyde (Capraldehyde), Dihydromyrcenol, Dihydromyrcenyl acetate, 3,7-Dimethyl-1-octanol, Diphenyloxide, Fenchyl Acetate (1,3,3-trimethyl-2-norbornanyl acetate), Geranyl acetate, Geranyl formate, Geranyl nitrile, cis-3-Hexenyl isobutyrate, Alpha-Ionone, Isobornyl acetate, Lauraldehyde, d-Limonene, Linalyl acetate, Methyl Chavicol (Estragole), Methyl n-nonyl acetaldehyde, Methyl octyl acetaldehyde, Beta-Myrcene, Nonaldehyde, p-Cymene, Alpha-Pinene, Beta-Pinene, Alpha-Terpinene, Gamma-Terpinene, Alpha-Terpinyl acetate, Tetrahydrolinalool, Tetrahydromyrcenol, 2-Undecenal, o-t-butylcyclohexyl acetate, 4-tert-butylcyclohexyl acetate.

In another aspect of Applicants' invention examples of suitable perfume materials that have a boiling point of less than or equal to 250° C. at 1 atmosphere, include but are not limited, to: Allyl caproate, Amyl acetate (n-pentyl acetate), Amyl propionate, p-Anisaldehyde, Benzaldehyde (Benezenecarboxaldehyde), Benzylacetate, Benzyl acetone, (+)-Camphor, L-Carvone, Cinnamic alcohol, Cis-3-hexenyl acetate, Citral (Neral), 2,4-dimethyl-3-cyclohexene-1-carboxaldehyde, Dimethyl benzyl carbinyl acetate, Ethyl acetoacetate, Ethyl amyl ketone, Eucalyptol, Eugenol, Fenchyl alcohol, tricyclodecenyl acetate, tricyclodecenyl propionate, Cis-3-Hexen-1-ol/Leaf alcohol, Hexyl acetate, Hydroxycitronellal, 2,3-dimethyl-3-cyclohexene-1-carboxaldehyde, Linalool, Linalool oxide, Linalyl formate, Menthone, Methyl anthranilate, Methyl benzoate, Methyl Phenyl Carbinyl Acetate (alpha-methylbenzyl acetate), Methyl eugenol (eugenol methyl ether), Methyl Heptine Carbonate (methyl 2-octynoate), Methyl heptyl ketone, Methyl hexyl ketone, Methyl salicylate, Delta-Nonalactone, Octyl aldehyde (caprylic aldehyde), p-Cresyl methyl ether, Phenylethyl alcohol, Prenyl acetate, methyl isao butenyl tetrahydro pyran, Terpinolene (alpha-Terpineol), Allo-ocimene, Allyl cyclohexanepropionate, Camphene, Citronellol, Citronellyl acetate, Citronellyl nitrile, Decyl Aldehyde (Capraldehyde), Dihydromyrcenol, Dihydromyrcenyl acetate, Fenchyl Acetate (1,3,3-trimethyl-2-norbornanyl acetate), Geranyl acetate, Geranyl formate, Geranyl nitrile, Alpha-Ionone, Isobornyl acetate, Lauraldehyde, d-Limonene, Linalyl acetate, Methyl Chavicol (Estragole), Methyl n-nonyl acetaldehyde, Methyl octyl acetaldehyde, Beta-Myrcene, Nonaldehyde, p-Cymene, Alpha-Pinene, Beta-Pinene, Alpha-Terpinene, Gamma-Terpinene, Tetrahydrolinalool, Tetrahydromyrcenol, 2-Undecenal, o-t-butylcyclohexyl acetate, 4-tert-butylcyclohexyl acetate.

The aforementioned perfume materials may be obtained from one or more of the following perfume material suppliers Firmenich (Geneva, Switzerland), Givaudan (Argenteuil, France), IFF (Hazlet, N.J.), Quest (Mount Olive, N.J.), Bedoukian (Danbury, Conn.), Sigma Aldrich (St. Louis, Mo.).

In one embodiment, one or more fragrances are either melt processed with the polymer material or are an intimate part of a coating, optionally a cured coating composition providing improved durability of the suggestive scent. The incorporation of the fragrances into the polymer products is performed by known methods such as dry blending in the form of a powder or wet mixing in the form of solutions, dispersions or suspensions, optionally in an inert solvent, water or oil. The fragrance(s) may be added directly into the processing apparatus (extruders, mixers, kneaders, etc.) in an inert atmosphere or ambient atmosphere. The present fragrance(s) may be added in the form of a masterbatch or polymer concentrate.

To provide the fragrance in a coating, a suitable coating material is applied, for example to a reservoir body, and optionally cured, if desired. The application of the fragrance(s) is for example performed by applying the dissolved or dispersed agents to the reservoir body, with or without subsequent evaporation of the solvent or the suspension/dispersion material. The fragrances can also be sprayed onto the reservoir body. In another exemplary embodiment, the fragrances are impregnated into the material of the reservoir.

In one exemplary embodiment, as illustrated in FIG. 2, the fabric article treating device 20 further comprises a reservoir 30 having a reservoir body 34 and an outer package 71. In one embodiment, the outer package 71 is configured to contain at least a portion of the reservoir body 34. The outer package 71 provides a scent suggestive of a scent provided by the benefit composition.

In another embodiment, as illustrated in FIG. 3, the reservoir 30 further comprises a coating 72 on the exterior portion of the reservoir body 34. In one exemplary embodiment, the coating 72 is adapted to provide a scent suggestive of a scent provided by the benefit composition.

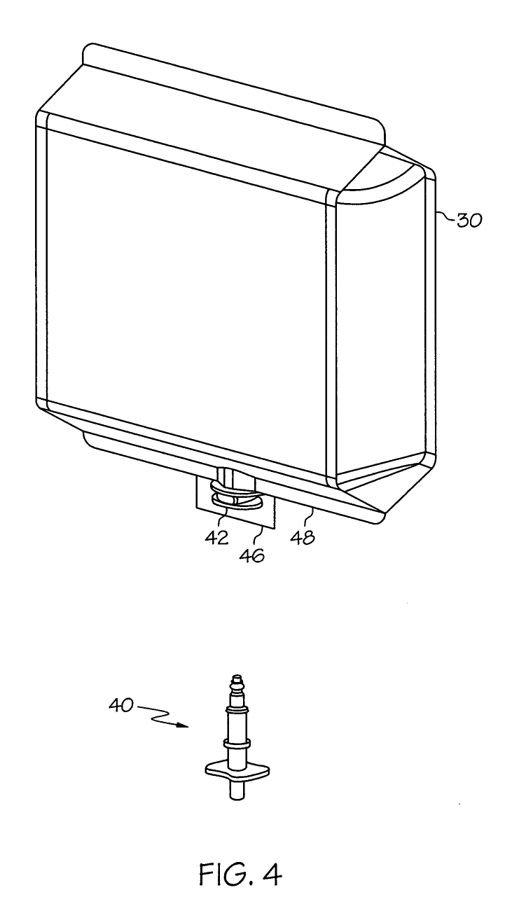

In a further embodiment of the present invention, as illustrated in FIG. 4, the reservoir 30 further comprises a closure fitment 46. The closure fitment 46 is adapted to cover a fitment 42 on the reservoir 30. In one exemplary embodiment, the cover fitment 46 provides a scent suggestive of a scent provided by the benefit composition. In another embodiment, the cover fitment 46 is formed of a material which provides a scent suggestive of a scent provided by the benefit composition. In an alternative embodiment, the cover fitment 46 further comprises a coating, wherein the coating is adapted to provide the scent suggestive of a scent provided by the benefit composition. In yet another alternative embodiment, the cover fitment 46 further comprises a cover liner, wherein the cover liner provides a scent suggestive of a scent provided by the benefit composition.

In one exemplary embodiment of the present invention, the reservoir 30 is adapted for location in an interior of the fabric article drying appliance 20. For example, the reservoir may be located in the chamber of the fabric article drying appliance. Alternatively, the reservoir may be located within the fabric article drying appliance, on an interior portion, but not within the chamber of the fabric article drying appliance.

The dispenser 25 may comprise at least one nozzle for the purposes of distributing the benefit composition into the fabric article drying appliance. Misting/atomizing of the benefit composition can be achieved using any suitable spraying device such as a hydraulic nozzle, sonic nebulizer, pressure swirl atomizers, high pressure fog nozzle or the like to deliver target particle size. Non-limiting examples of suitable nozzles include nozzles commercially available from Spray Systems, Inc. of Pomona, Calif. under the Model Nos. 850, 1050, 1250, 1450 and 1650. Another suitable example of a nozzle is a pressure swirl atomizing nozzle made by Seaquist Perfect Dispensing of Cary, Ill. under Model No. DU-3813.

In the exemplary embodiment illustrated in FIG. 4, the fabric article treating device 20 further comprises fitment 40, one of corresponding male and female fitments and the reservoir 30, shown as a sealed pouch or carton, comprises the other fitment 42 of the corresponding male and female fitments, wherein the female fitment is configured to receive the male fitment to establish the fluid communication between the dispenser 25 and the reservoir 30. In the embodiment of FIG. 4, the fitment 42 on the reservoir 30 is the female fitment, while the corresponding male fitment 40 is adapted for fluid connection with the dispenser 25, for example via a fluid handling system as described hereafter. Various corresponding male and female fitments which establish fluid communication are generally known in the art and are suitable for use herein. One exemplary fitment that may be utilized is available from IPN USA Corp. of Peachtree City, Ga., available as available as Clean-Clic® pouch fitments, model number SBS-4. As one skilled in the art will appreciate, any fitments can be utilized in the present invention provided the fitments are configured to maintain fluid communication between the reservoir 30 and the dispenser 25. In one embodiment, one or more fitments are adapted to provide a scent suggestive of a scent provided by the benefit composition. In an alternative embodiment, the fitment 42 of the reservoir 30 comprises a coating, wherein the coating is adapted to provide a scent suggestive of a scent provided by the benefit composition.

In another embodiment, the exterior portion of the reservoir, which provides a scent suggestive of a scent provided by the benefit composition, is located in proximity to the fitment, indicated by reference numeral 48. For example, a consumer may try to smell the benefit composition in the reservoir through the fitment. By adapting an exterior portion of the reservoir in proximity to the fitment, the consumer may be able to smell a scent provided on the exterior portion suggestive of a scent provided by the benefit composition.

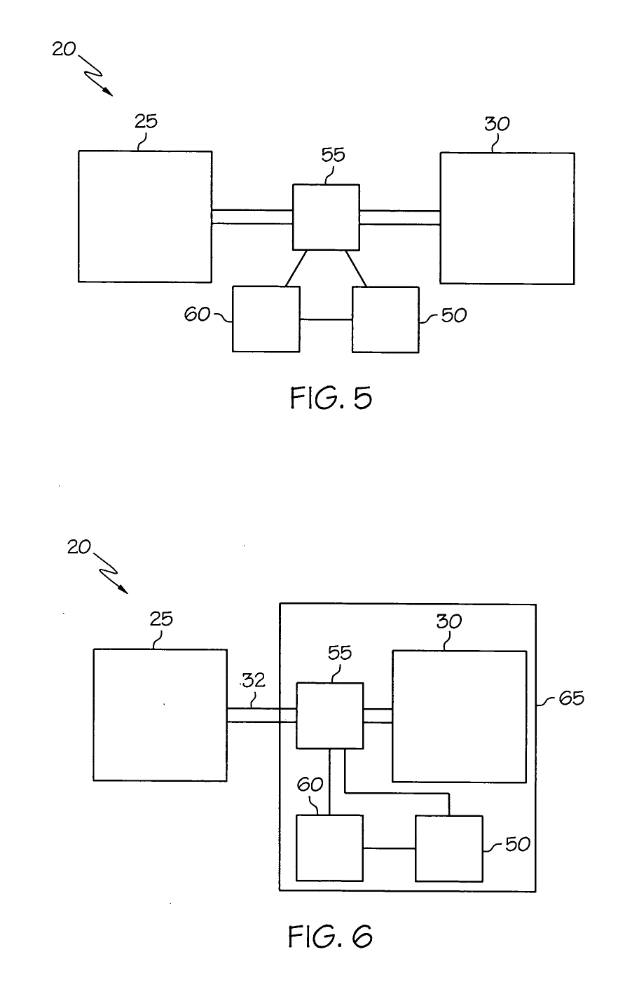

In one exemplary embodiment, as illustrated in FIG. 5, the fabric article treating device 20 further comprises a fluid handling system 55, a power source 50 and a controller 60. In one exemplary embodiment, the fluid handling system 55 is configured to transport the benefit composition from the reservoir 30 to the dispenser 25. The dispenser 25 is configured to deliver the benefit composition to one or more fabric articles in the fabric article drying appliance. The power source 50 is configured to provide electrical power as needed by the fluid article treating device, such as the controller 60, the fluid handling system 55, sensors, and any electrical needs of a user interface. The controller 60 is configured to regulate the dispensing of the benefit composition. For example, the controller 60 may determine the optimum time to dispense the benefit composition, the quantity of benefit composition to be dispensed and the rate at which to dispense the benefit composition. In one embodiment, the fabric article treating device further comprises a communication link adapted to provide communication between the controller of the fabric article treating device and the fabric article drying appliance. For example, the controller may send and/or receive signals to/from the fabric article drying appliance to determine the optimum benefit composition dispensing conditions such as, time, length, etc.

Another exemplary embodiment of the present invention is illustrated in FIG. 6. In this exemplary embodiment, the fabric article treating device 20 further comprises a housing 65. The housing 65 is adapted to receive various components of the fabric article treating device, optionally, the housing may substantially enclose and protect the components in their assembled form. For example, as shown in FIG. 6, the housing may receive the power source 50, the fluid handling system 55, the controller 60 and the reservoir 30. In another embodiment, the housing may comprise a tubing storage area adapted to contain a quantity of fluid line 32 to allow the user to customize the installation of the fabric article treating device for the user's particular fabric article drying appliance. The housing 65 may be constructed with any materials known to one skilled in the art. Exemplary materials include but are not limited to polymers, metals, fabric, wood, and the like. The housing 65 may be located on an exterior portion or an interior portion of the fabric article drying appliance.

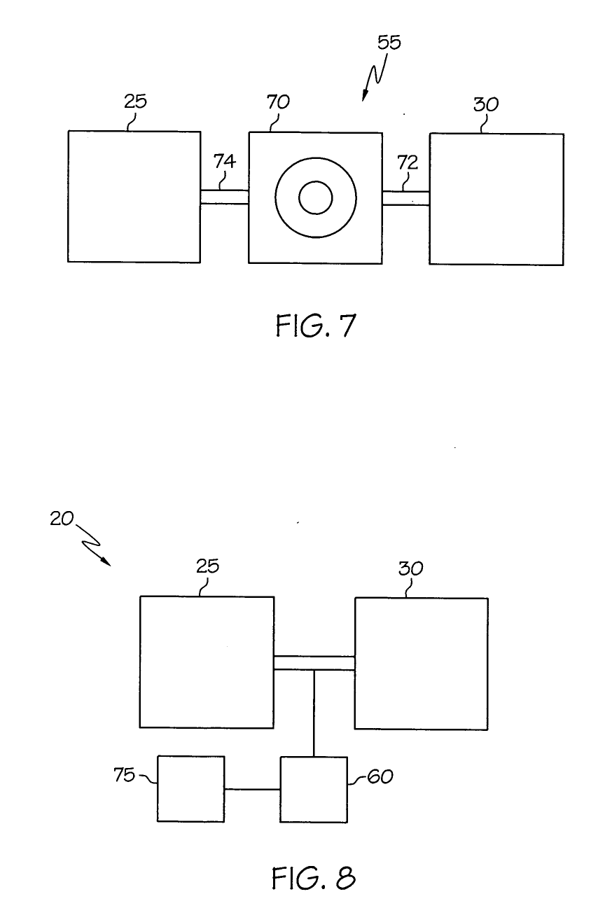

In one exemplary embodiment as illustrated in FIG. 7, the fluid handling system 55 comprises a pump 70. The pump 70 is in communication with the reservoir 30 and the dispenser 25 via fluid lines 72 and 74, respectively. The pump 70 is configured to transport benefit composition from the reservoir 30 to the dispenser 25 for dispensing of the benefit composition. In one embodiment, the pump 70, comprises a piezoelectric pump. In another embodiment, the pump 70 may comprise a diaphragm pump. As one skilled in the art will appreciate any pump known to one skilled in the art may be utilized to transport the benefit composition from the reservoir 30 to the dispenser 25. Other exemplary pumps include piston pumps, peristaltic pumps, and bellows-type pumps.

As noted above, one type of pump 70 that can be used in the present invention is a piezo-electric pump. While a piezo-electric pump has certain membranes or laminations which may vibrate in a reciprocating-type fashion, the piezo-electric pumps generally do not have major moving parts, such as rotating shaft and bearings used with a rotator member to displace a fluid or gaseous fluid, that experience wear over time. One commercially available suitable piezo-electric pump usable in the present invention is manufactured by PAR Technologies, LLC, located in Hampton, Va., and marketed as the “LPD-Series” laminated piezo-electric fluid pumps. Pumps which draw a relevantly low current are particularly suitable in certain embodiments.

In another embodiment, the reservoir 30 may be positioned in such a way to provide gravitation flow of the benefit composition to the dispenser 25. For example, the reservoir 30 may be mounted above the fabric article drying appliance to create static head on the benefit composition to allow dispensing of the benefit composition without the utilization of a pump.

Another exemplary embodiment of the present invention is illustrated in FIG. 8. In this embodiment, as in previously discussed embodiments, the fabric article treating device 20 comprises a dispenser 25 adapted for location inside of a fabric article drying appliance and a reservoir 30 adapted to contain a benefit composition, wherein an exterior portion of the reservoir 30 provides a scent suggestive of a scent provided by the benefit composition. The dispenser 25 and the reservoir 30 are adapted for fluid communication with one another. The device further comprises a controller 60 in electrical communication with a sensor 75. In one exemplary embodiment, the sensor comprises a temperature sensor. In another exemplary embodiment, the sensor 75 comprises a light sensor. In yet another exemplary embodiment, the sensor 75 comprises a motion sensor. The controller 60 is adapted to send and/or receive signals from the sensor 75 and to determine the dispensing conditions for dispensing the benefit composition. The controller may then be adapted to control delivery of the benefit composition to the dispenser.

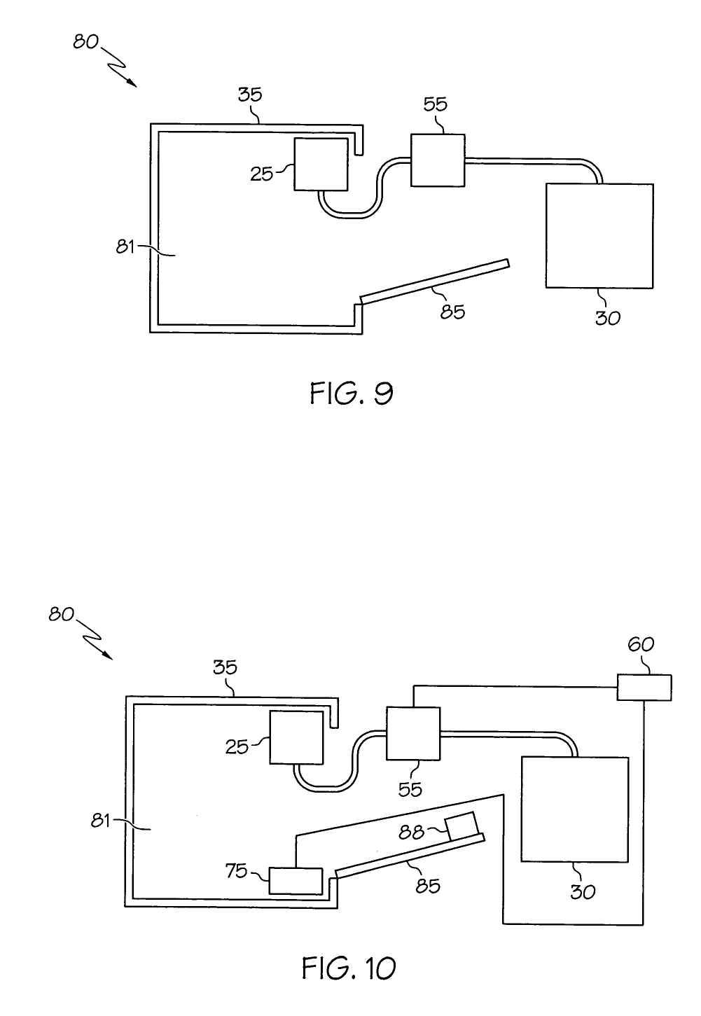

Another embodiment of the present invention, as illustrated in FIG. 9, is a fabric article treating system 80. The fabric article treating system 80 comprises a fabric article drying appliance 35 having a chamber 81 and a closure structure 85, for example, a door. The closure structure 85 has a closed position and at least one open position. The closure structure 85 allows access to the chamber 81 of the fabric article drying appliance 35. The fabric article treating system 80 further comprises a reservoir 30 for containing a benefit composition; a dispenser 25 in communication with the chamber 81; and a fluid handling system 55 that transfers the benefit composition from the reservoir 30 toward the dispenser 25, thereby dispensing the benefit composition into the chamber 81. An exterior portion of the reservoir 30 is adapted to provide a scent suggestive of a scent provided by the benefit composition, and as discussed above, the reservoir 30 may be removable. In another embodiment, the reservoir 30 comprises a sealed pouch.

Another embodiment of the present invention, as illustrated in FIG. 10, is a fabric article treating system 80. The fabric article treating system 80 comprises a fabric article drying appliance 35 having a chamber 81 and a closure structure 85. The closure structure 85 has a closed position and at least one open position, wherein the closure structure 85 allows access to the chamber 81. The fabric article treating system 80 further comprises a reservoir 30 for containing a benefit composition and a dispenser 25 in communication with the chamber 81; a fluid handling system 55 that compels the benefit composition from the reservoir 30 toward the dispenser 25, thereby dispensing the benefit composition into the chamber 81; a closure structure sensor 88; and a controller 60 that initiates dispensing of the benefit composition. The controller 60 is configured to prevent the benefit composition from being dispensed when the closure structure sensor 88 indicates that the closure structure 85 is not in the closed position. An exterior portion of the reservoir 30 is adapted to provide a scent suggestive of a scent provided by the benefit composition. In another embodiment, the fabric article treating system 80 further comprises one or more additional sensors 75 in the chamber in communication with the controller.

The reservoir 30 may be mounted on an exterior portion of the fabric article drying appliance 35, such as on the fabric article drying appliance closure structure 85, or a side wall, a top wall, an outer surface of a top-opening lid, or the like, including a stand, wall or other household structure that is separate from the fabric article drying appliance. Moreover, the reservoir 30 may be mounted on any interior portion of the fabric article drying appliance 35, examples of which include, but are not limited to, the interior surface of the closure structure 85, the drum of the fabric article drying appliance, the back wall, the inner surface of a top opening lid, or the like.

Optionally, filters and/or filtering techniques can be used to filter the benefit composition, if desired, for example at a point between the reservoir 30 and the outlet of the dispenser 25. Non-limiting examples of this include: utilizing a filter in the dispenser 25 prior to dispensing of the benefit compositions. Alternatively, the benefit composition may be filtered prior to dispensing into the reservoir; or a combination of filtering techniques may be employed.

The dispenser 25 and the reservoir 30 are adapted for fluid communication with one another. In one embodiment, the dispenser 25 and the reservoir 30 may be in electrical connection with one another. Non-limiting examples of means for connecting the dispenser 25 and the reservoir 30 may include utilizing a flat cable (also referred to as a ribbon cable), a wire, a wire or group of wires enclosed in a sheet of woven or nonwoven material, a conduit (a non-limiting example of which is a conduit for the benefit composition), or combination thereof. The woven or nonwoven sheet may be used as a method of attaching the dispenser 25 and the reservoir 30. The dispenser 25 and the reservoir 30 may be used to provide a means of gravitational counterbalancing so as to reduce unnecessary tension on the wires and/or the connections.

The power source 50 may comprise chemical batteries, or any electrical power source, including standard household line voltage, or even solar power. Batteries may be utilized, and are particularly suitable when the fabric article treating device 20 is in the form of an add-on device for an existing fabric article drying appliance 35. However, any appropriate power adapter can be provided to convert an AC power source to the appropriate DC voltages used in any electrical components of the fabric article treating device 20, such as in the fluid handling system 55, the controller 60, and any sensors 75.

As noted, the fabric article treating device 20 can include optional sensors 75. Non-limiting examples of optional sensors include a door (or lid sensor), a motion sensor, a humidity sensor, and/or a temperature sensor. One non-limiting example of a door/lid sensor is an optoelectronic device, such as an optocoupler or an optical input sensor, e.g., a phototransistor or photodiode. When the door/lid of the drying appliance is open, the door sensor will change state, and will output a different voltage or current level along an electrical conductor that leads from the door sensor back to the controller. This can be used as a safety device to immediately interrupt the dispensing of the benefit composition from the dispenser 25. The optional door sensor could be utilized even when a control system is integrated into the overall conventional control system of the drying appliance. For example, a drying appliance typically has its own door sensor which shuts off the rotating drum of the dryer when the door becomes open. In this instant, the optional door sensor can act as a backup or second door sensor to the dryer's internal original sensor that shuts off the rotating drum. One example which could be used as a door/lid sensor is an NPN Phototransistor, Part No. PNA1801L, manufactured by Panasonic, of Osaka, Japan. In another embodiment, a communication link could be established between the drying appliance and the controller, wherein the drying appliance would send the controller a signal relating to the operational state of the drying appliance (e.g., door open/closed, drying cycle, temperature, etc.).

Another type of optional sensor 75 that can be utilized by the fabric article treating device 20 of the present invention is a motion sensor. For fabric article drying appliances 35 which utilize a moving interior, such as a rotating drum, the motion sensor can detect if a fabric article drying appliance is in use. One example of a motion sensor is a vibration and movement sensing switch manufactured by ASSEM Tech Europe Ltd., of Clifton, N.J., available as Model No. CW1600-3. Another type of optional motion sensor that may be used in the present invention uses a light source to direct (infrared) light at a surface, and the relevant motion of that surface can be detected by the intensity and/or frequency of the returning light. Such sensors can measure the actual speed of rotation, if that information is desired.

Another optional sensor 75 that can be used in a fabric article treating device 20 of the present invention is a humidity sensor. The optional humidity sensor, together with the controller, may be used to control the amount of composition being dispensed by the dispenser 25, and also may be utilized to determine the proper environmental conditions during an operational cycle in which the dispensing event should take place. Additionally, this humidity sensor may be used to maintain a specific humidity by controlling the dispensing the benefit composition such that optimal de-wrinkling and/or other benefits are achieved. Many different types of humidity sensors could be used in conjunction with the present invention, including variable conductivity sensors. One such sensor is manufactured by Honeywell, of Freeport, Ill. under the Model No. HIH-3610-001, although any of the HIH-3610 series or any other available sensor may be used.

A further optional sensor 75 that can be useful in the fabric article treating device 20 of the present invention is a temperature sensor, such as one that outputs an analog or digital signal along the electrical conductor that leads back to the controller.

As noted above, the fabric article treating device 20 may comprise a controller 60. In one embodiment, the controller may be a microcontroller. A suitable microcontroller is manufactured by MicroChip, of Chandler, Ariz. under the Part No. PIC16LS876-04/P. However, other microcontrollers made by different manufacturers could also easily be used. In one exemplary embodiment, the microcontroller includes on-board random access memory (RAM), on-board read only memory (ROM), which comprises electrically programmable non-volatile memory elements, as well as on-board input and output lines for analog and digital signals. The controller may also be used with a crystal clock oscillator, although a RC circuit could be used instead as a clock circuit, if desired. The clock circuit provides the timing of the clock as necessary to operate the controller. In one embodiment, the controller comprises a port that can be interfaced to an optional programmable interface using a communication link, such as RS-232 communication link. The port allows a user to alter the program information of the controller, such as dispensing options, etc.

One skilled in the art will appreciate that the controller can be any type of microprocessor or microcontroller circuit commercially available, either with or without on-board RAM, RAM, or digital and analog input/output (I/O). Moreover, a sequential processor may be used to control the fabric article treating device 20, or alternatively a parallel processor architecture or a logic state machine architecture could be used. Furthermore, the controller 60 may be integrated into an Application Specific Integrated Circuit (ASIC) containing many other logic elements that could be used for various functions, as desired, such functions being optional depending upon the model of the fabric article treating device 20 that will be sold to a consumer. To change model features, the manufacturer need only program the ASIC or the on-board RAM of the controller according to the special parameters of that particular model, while using the same hardware for each of the units.

It will also be understood that discrete digital logic could be used instead of any type of microprocessor microcontroller unit, or analog control circuitry could be used along with voltage comparators and analog timers, to control the timing events and to make decisions based on input levels of the various sensors that are provided with the fabric article treating device 20.

It will be understood that the present invention can be readily used in other types of fabric “treating” devices, and is not limited solely to clothes “dryers”. In the context of this patent document, the terms “dryer” or “drying apparatus” or “fabric article drying appliance” include devices that may or may not perform a true drying function, but may involve treating fabric without attempting to literally dry the fabric itself. As noted above, the terms “dryer” or “drying apparatus” or “fabric article drying appliance” may include a “dry cleaning” process or apparatus, which may or may not literally involve a step of drying. The term “fabric article drying appliance” as used herein, also refers to any fabric treating device that utilizes moving air directed upon one or more fabric articles, a non-limiting example of which includes a clothes dryer, and modifications thereof. Such devices include both domestic and commercial drying units used in dwellings, laundromats, hotels, and/or industrial settings. In addition, it should be noted that some drying appliances include a drying chamber (or “drum”) that does not literally move or rotate while the drying appliance is operating in the drying cycle. Some such dryers use moving air that passes through the drying chamber, and the chamber does not move while the drying cycle occurs. Such an example dryer has a door or other type of access cover that allows a person to insert the clothing to be dried into the chamber. In many cases, the person hangs the clothes on some type of upper rod within the drying chamber. Once that has been done, the door (or access cover) is closed, and the dryer can begin its drying function. Dispensing of a benefit composition can take place within such a unit, however, care should be taken to ensure that the benefit composition becomes well dispersed within the drying chamber, so that certain fabric items do not receive a very large concentration of the benefit composition while other fabric items receive very little of the benefit composition.

Exemplary fabric article treating devices and systems include those described in co-pending U.S. application Ser. No. 10/697,735 filed on Oct. 29, 2003; U.S. application Ser. No. 10/697,685 filed on Oct. 29, 2003; U.S. application Ser. No. 10/697,734 filed on Oct. 29, 2003; U.S. application Ser. No. 10/697,736 filed on Oct. 29, 2003; and U.S. application Ser. No. 10/762,152 filed on 10/762,152.

All documents cited in the detailed description of the invention are, in relevant part, incorporated herein by reference; a citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXEMPLARY PERFUME COMPOSITION EXAMPLES

### PERFUME EXAMPLE A

| | |
|---|---|
| Linalool | 32.00 |
| Citronellol | 14.00 |
| cyclohexanemethanol,4-(1-methylethyl)-,cis | 7.00 |
| Citronellyl Acetate | 3.00 |
| Benzyl Acetate | 3.00 |
| P. T. Bucinal | 14.00 |
| Indole | 1.00 |
| Cumin Oil | 0.25 |
| Methyl Dihydro Jasmonate | 6.50 |
| Cis 3 Hexenyl Acetate | 0.50 |
| Hexyl Cinnamic Aldehyde | 6.50 |
| lonone Gamma Methyl | 2.00 |
| 2H-Pyran-4-ol,tetrahydro-4-methyl-2-(2methylpropyl)- | 8.00 |
| Castoreum Synthetic-3c (conf.-giv) | 0.50 |
| Cinnamic Alcohol | 1.75 |

### PERFUME EXAMPLE B

| | |
|---|---|
| Amyl Butyrate | 1.20 |
| Dimethyl Benzyl Carbinyl Acetate | 4.50 |
| Ethyl malthol 1% in DPG | 0.50 |
| Ethyl-2-methyl butyrate | 5.00 |
| ethyl methyl dioxolane acetate | 12.00 |
| 1,3,4,6,7,8-hexahydro-4,6,6,7,8,8-hexamethyl- | 20.00 |
| cyclopenta-gamma-2-benzopyran | |
| Hexyl Cinnamic Aldehyde | 3.40 |
| Prenyl Acetate | 3.70 |
| 2,3-dimethyl-3-cyclohexene-1-carboxaldehyde | 0.70 |
| (Ligustral) | |
| Undecalactone | 10.00 |
| o-t-butylcyclohexyl acetate (Verdox) | 30.00 |

### PERFUME EXAMPLE C

| | |
|---|---|
| D-limonene | 99.00 |
| Decyl Aldehyde | 0.25 |
| Alpha Pinene | 0.25 |
| Octyl Aldehyde | 0.25 |
| Sinensal | 0.25 |

1. A fabric article treating device, comprising:
a dispenser adapted for location inside of a fabric article drying appliance; and
a reservoir containing a benefit composition, wherein the reservoir and the dispenser are in fluid communication;
wherein an exterior portion of the reservoir provides a scent suggestive of a scent provided by the benefit composition.

2. The fabric article treating device of claim 1, wherein the exterior portion of the reservoir comprises a reservoir body formed of a material impregnated with a fragrance.

3. The fabric article treating device of claim 1, wherein the reservoir comprises a body and an outer packaging, and wherein the outer packaging provides a scent suggestive of a scent provided by the benefit composition.

4. The fabric article treating device of claim 3, wherein the outer packaging comprises a material impregnated with a fragrance.

5. The fabric article treating device of claim 1, wherein the exterior portion of the reservoir comprises an exterior coating on the reservoir.

6. The fabric article treating device of claim 1, wherein the reservoir comprises an exterior fitment adapted to provide fluid communication of the benefit composition between the dispenser and the reservoir.

7. The fabric article treating device of claim 6, wherein the exterior portion is located in proximity to the fitment.

8. The fabric article treating device of claim 1, wherein the reservoir comprises a pouch.

9. The fabric article treating device of claim 1, wherein the reservoir comprises a single or multi-layer barrier film.

10. The fabric article treating device of claim 9, wherein the reservoir comprises a multi-layer barrier film having an outer layer and at least one inner layer, and wherein the outer layer comprises the exterior portion providing a scent suggestive of a scent provided by the benefit composition.

11. The fabric article treating device of claim 1, wherein the exterior portion of the reservoir comprises a cover fitment.

12. The fabric article treating device of claim 11, wherein the cover fitment comprises a material impregnated with a fragrance.

13. The fabric article treating device of claim 11, wherein the cover fitment comprises a liner.

14. The fabric article treating device of claim 13, wherein the liner comprises a material impregnated with a fragrance.

15. The fabric article treating device of claim 11, wherein the cover fitment comprises a fragrance coating.

16. The fabric article treating device of claim 1, wherein the exterior portion of the reservoir comprises a fragrance coating.

17. A fabric article treating device comprising:
a reservoir adapted for containing a benefit composition; and
a fitment configured to preserve the anaerobic environment within the reservoir during storage of the benefit composition in the reservoir and dispensing of the benefit composition from the reservoir;
wherein an exterior portion of the reservoir provides a scent suggestive of a scent provided by the benefit composition.
